(19) United States
(12) Patent Application Publication
(10) Pub. No.: US 2011/0301298 A1
(43) Pub. Date: Dec. 8, 2011

(54) ACID FUNCTIONALIZED GRADIENT BLOCK COPOLYMERS

(75) Inventors: Scott C. Schmidt, West Chester, PA (US); Peter A. Callais, Conroe, TX (US); Noah E. Macy, Royersford, PA (US); Jason S. Ness, East Norriton, PA (US)

(73) Assignee: Arkema Inc., King of Prussia, PA (US)

(21) Appl. No.: 13/209,716

(22) Filed: Aug. 15, 2011

Related U.S. Application Data
(62) Division of application No. 12/302,105, filed on Nov. 24, 2008, now abandoned.
(60) Provisional application No. 60/808,407, filed on May 25, 2006.

(51) Int. Cl. C08F 293/00

(52) U.S. Cl. 525/299

(57) ABSTRACT

The present invention relates to a class of acid functionalized gradient block copolymers, processes for obtaining them and to their uses including but not limited to hair fixatives, toughening agents, and adhesives. Surprisingly, the applicants have discovered the aforementioned class of acid functionalized gradient block copolymers have advantageous properties and can find utility in a wide variety of application areas. These polymers are easily prepared by sequential monomer addition (i.e., “one-pot” synthesis) and the process does not require any post polymerization modification steps. The aforementioned polymers are derived from commonly utilized monomers. The use of common monomers provides both an economic advantage and an inherent safety advantage, e.g., the common monomers are considered biocompatible.

This application is a Divisional filing of U.S. application Ser. No. 12/302,105 filed Nov. 24, 2008 which is a National Phase Application of, and claims priority to International Application No. PCT/US07/69503 filed May 23, 2007, which claims priority to U.S. provisional application Ser. No. 60/808,407 filed May 25, 2006.

### FIELD OF THE INVENTION

The present invention relates to a novel class of acid functionalized gradient block copolymers. The acid functionalized gradient block copolymers of the present invention have advantageous properties and can find utility in a wide variety of application areas. The polymers are easily prepared by sequential monomer addition (i.e., “one-pot” synthesis) and the process does not require any post polymerization modification steps. These polymers can be synthesized by bulk, solution, suspension, or emulsion polymerization processes. The aforementioned polymers are derived from commonly utilized monomers.

### BACKGROUND

Acrylic acid (AA) is widely known and used to affect properties such as adhesion, swelling, and solubility. It can also be used to impart pH dependant properties and to provide a functional group capable of undergoing post polymer reactions. The applicants have discovered that combining the favorable characteristics of AA with the desirable properties of both block and gradient copolymers leads to materials having advantageous effects on end use properties and simplifies manufacturing. Methacrylic acid can be used in place of acrylic acid. Also, one could incorporate a monomer that is easily modifiable into the acid form, e.g., an anhydride or protected acid ester which can be hydrolyzed in a post polymer modification step as will be known to those skilled in the art. Furthermore, by tailoring the monomer composition and sequencing, the end-use polymer properties can be customized. For example, the use of AA as a comonomer with a hydrophobic low Tg (glass transition temperature) monomer such as butyl acrylate or ethylhexyl acrylate will allow for improved adhesion to substrates such as glass, hair, or metal. Also, the hydrophilic and ionic character of AA also improves the solubility properties in both polar organic solvents and water. Furthermore the use of AA as a comonomer to achieve the aforementioned favorable properties eliminates the need to rely on other more expensive or potentially toxic hydrophilic monomer alternatives such as dimethyl acrylamide, dimethyl amino ethyl methacrylate, or methoxy ethyl acrylate.

The use of gradient block structures allows the final polymer properties to be tuned further. For example, the properties obtained in traditional copolymers are typically an average of the properties imparted by the resultant monomers incorporated, while block copolymers lead to a composite material containing the characteristic properties inherent to each parent polymer block sepnent. The gradient structure allows for the tuning of each block segment and further simplifies the polymer synthesis process. One example is tailoring a segment Tg, e.g., by creating a gradient of a low Tg monomer in a high Tg polymer segment allows one to reduce the overall Tg of the segment.

US Pat. No. 6,887,962 and patent application 2004/0180019 give examples of gradient polymers made by controlled radical polymerization (CRP). Neither patent discloses the use of a gradient structure in combination with block copolymers and AA.

By “copolymers” as used herein, is meant polymers formed from at least two chemically distinct monomers. Copolymers include terpolymers and those polymers formed from more than three monomers. Each block segment can consist of a copolymer of two or more different monomers.

Block copolymers of the present invention are preferably those formed by controlled radical polymerization (CRP), nitroxide mediated CRP is a preferred route. Exemplary nitroxides are disclosed in U.S. Pat. No. 6,255,448 (incorporated herein by reference). Disclosed therein are stable free radicals from the nitroxide family comprising a sequence of formula:

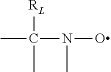

in which the R_{L}radical has a molar mass greater than 15. The monovalent R_{L} radical is said to be in the beta position with respect to the nitrogen atom of the nitroxide radical. The remaining valencies of the carbon atom and of the nitrogen atom in the formula (1) can be bonded to various radicals such as a hydrogen atom or a hydrocarbon radical, such as an alkyl, aryl or aralkyl radical, comprising from 1 to 10 carbon atoms.

Such block copolymers differ from random copolymers that may contain some blocks of certain monomers related either to a statistical distribution, or to the differences in reaction rates between the monomers. In these random polymerizations, there is virtually no control over the polymer architecture, molecular weight, or polydispersity and the relative composition of the individual polymer chains is non-uniform. Block copolymers of the present invention include diblock copolymers, triblock copolymers, multiblock copolymers, star polymers, comb polymers, gradient polymers, and other polymers having a blocky structure, which will be known by those skilled in the art.

When a copolymer segment is synthesized using a CRP technique such as nitroxide-mediated polymerization, it is termed a gradient or ‘profiled’ copolymer. This type of copolymer is different than a polymer obtained by a traditional free radical process and the copolymer properties will be dependant on the monomer composition, control agent employed, and polymerization conditions. For example, when polymerizing a monomer mix by traditional free radical polymerizations, a statistical copolymer is produced, as the composition of the monomer mix remains static over the lifetime of the growing chain (approximately 1 second). Furthermore, due to the constant production of free radicals throughout the reaction, the composition of the chains will be non-uniform. During a controlled radical polymerization the chains remain active throughout the polymerization, thus the composition is uniform and is dependant on the corresponding monomer mix with respect to the reaction time. Thus in a two monomer system where one monomer reacts faster than the other, the distribution or ‘profile’ of the monomer units will be such that one monomer unit is higher in concentration at one end of the polymer segment.

The copolymers of the invention are acrylic block copolymers. By acrylic block copolymer, as used herein, is meant that at least one block of the copolymer is formed from one or more acrylic monomers. The acrylic block contains at least 5 mole percent of acrylic monomer units, preferably at least 25 mole percent, and most preferably at least 50 mole percent. In one preferred embodiment, the acrylic block contains 100 percent acrylic monomer units. The other block or blocks may be acrylic or non-acrylic.

By “acrylic” as used herein is meant polymers or copolymers formed from acrylic monomers including, but not limited to, acrylic acids, esters of acrylic acids, acrylic amides, and acrylonitiles. It also includes alkacryl derivatives, and especially methacryl derivatives. Functional acrylic monomers are also included. Examples of useful acrylic monomers include, but are not limited to acrylic acid; methacrylic acid; alkyl esters and mixed esters of (meth)acrylic acid; acrylamide, methacrylamide, N. and N,N-substituted (meth)acrylamides, acrylonitrile, maleic acid, fumaric acid, crotonic acid, itaconic acid and their corresponding anhydrides, carbonyl halides, amides, amidic acids, amidic esters, and the full and partial esters thereof. Especially preferred acrylic monomers include acrylic acid, methacrylic acid, methyl acrylate, ethyl acrylate, butyl acrylate, and other C₆-C₂₂ alkyl (meth)acrylates, and mixtures thereof.

An example of a gadient block copolymer is when the monomer or monomers used from one segment are allowed to further react as a minor component in the next sequential segment. For example, if the monomer mix used for the ^{1st} block (A block) of an AB diblock copolymer is polymerized to only 80% conversion, then the remaining 20% of the unreacted monomer is allowed to react with the new monomers added for the B block segment the result is an AB diblock copolymer in which the B segment contains a gradient of the A segment composition.

ABA triblock thermoplastic elastomers where one or both of the A segment or B segment are acid functionalized are one useful type of acid functionalized gradient block copolymers. As previously discussed, the elasticity, Tg, adhesion properties, solubility, etc. can be tailored by varying the monomer composition and amount and placement of acid functionality.

### DETAILED DESCRIPTION OF THE INVENTION

The present invention is directed toward a novel class of acid functionalized gradient block copolymers. Included, as block copolymers are diblock copolymers, triblock copolymers, multiblock copolymers, star polymers, comb polymers, and other polymers having a blocky structure, Which will be known by those skilled in the art. In one preferred embodiment, the block copolymers of the present invention contain a gradient composition in which the monomer(s) from at least one distinct segment are incorporated as a gradient in an adjacent segment. One or more of the block segments will contain acid functionality. Preferably more than one segment will contain acid functionality. Preferably the acid functionality will arise from the use of acrylic acid or methacrylic acid. Through the combination of block copolymers, gradient copolymers, and acid containing functionality one can efficiently tailor the properties of polymeric materials, through the judicial selection of segment composition and by employing a rational design of polymer architecture. As an example, one can significantly alter the properties of well-known polymethylmethacylate-block-polybutylacrylate-biock-polymethylmethacrylate (PMMA-PBA-PMMA) block copolymers by introducing a gradient profile and incorporating acid functionality. The aforementioned triblock is not water soluble, nor does it have an affinity to absorb water. If acid is incorporated into both blocks via a gradient profile, a water-soluble polymer can be obtained especially upon neutralization. If the acid is selectively kept in the midblock segment the material will behave as a hydrogel and if the acid is selectively sequestered in the endblocks the polymer will act as a thickening agent. The mechanical properties can be further tuned by incorporating other monomers into the gradient profile. For example, butylacrylate (BA) can be carried over from the midblock as a gradient into the endblocks to further reduce the modulus and the Tg of the resultant triblock.

By altering the gradient structure and the relative acid composition and architecture the present invention allows for the production of block copolymers having tailored properties such as adhesion, swelling, solubility, pH dependency, rheological properties and mechanical properties.

Description of Process to Make Polymers:

Another aspect of the invention is directed towards a simple process for producing acid containing gradient blocks as is described below in examples 1 through 6. Controlled polymerization techniques familiar to those skilled in the art can be used. The preferred method is controlled radical polymerization, most preferably nitroxide mediated controlled radical polymerization. A wide range of monomers can be used with the aforementioned controlled polymerization techniques as will be evident to those skilled in the art. Monomers include, but are not limited to, acrylic acids, esters of acrylic acids, acrylic amides, and acrylonitiles also including alkacryl derivatives, and especially methacryl derivatives. Fluorinated, or silyl containing (meth)acrylate monomers are included as well as non-acrylate monomers such as vinyl aromatics, substituted vinyl aromatics, and dienes.

The acid containing gradient block copolymers of the present invention can be used in a wide variety of applications, such as, compatibilizing agents, thermoplastic elastomers, impact modifiers, adhesives, thickeners, hair fixatives, controlled delivery (pharmaceutical, pesticide, fragrance, etc) matrix, cosmetic applications, surfactants, foaming agents, low surface energy additives (for anti-stain, anti-soil, or anti-stick applications, for wetting or coating applications, and anti-fouling applications), coatings for medical devices, lubricants, and many others as will be evident to those skilled in the art.

These polymers can be used in additive amounts or used as bulk materials, Additive amounts may be included in a wide variety of bulk polymers to impart properties such as impact resistance that are not inherent in the bulk polymers.

The following examples are representative of the present invention and not to be considered limiting. While bulk and solution polymerization examples are exemplified, these techniques can be extended to both suspension and emulsion polymerization processes.

### EXAMPLES

### Example 1

### Preparation of an Acid Functionalized Polymethyl Methacrylate-Polybutyl Acrylate Gradient Block Copolymer

Difunctional Initiator Synthesis:

47.0 grams (0.237 moles) of 1,4-butanediol diacrylate were mixed with 355.9 grams of absolute ethanol and bubbled with nitrogen for 10 minutes. The mixture was then added to 190.25 grams (0.499 moles) of BlocBuilder® alkoxyamine free radical polymerization controller (available from Arkema Inc.). The resulting solution was brought to reflux (78-80° C.) while stirring and held for 4 hours to complete the reaction. NMR shows reaction is >95% of the new dialkoxyamine. Therefore, the solution in ethanol is approximately 38% active.

First Block Synthesis:

33.9 grams (0.0134 moles) of dialkoxyamine solution from above were mixed with 31.4 grams (0.435 moles) acrylic acid and 550 grams (4.29 moles) of butyl acrylate in a suitable container. The mixture was bubbled with nitrogen for 10 minutes to deactivate the inhibitor present in the monomers. Following that treatment, the solution was poured into a 1 L stainless steel polymer reactor, capable of handling >100psi, with mechanical stirring and sampling valve. Polymerization was carried out at 110-120° C. until 80% conversion (about 3 hours). The resulting first block mixture was diluted with 500 grams of toluene.

Triblock Copolymer Synthesis:

500 grams of the diluted first block solution was mixed with 88.5 grams (0.89 moles) methyl methacrylate and 15.7 grams (0.22 moles) of acrylic acid. This mixture was bubbled with nitrogen for 30 minutes and then polymerized in the same reactor as above for one hour at 105° C., followed by 2 hours at 115° C. Overall conversion of second block was 85%. Solvent and residual monomers were removed under vacuum at 115-130° C. The resulting polymer is a ABA triblock copolymer, in which the B block contains a copolymer of butyl acrylate and acrylic acid (BA/AA) and the A blocks contain a polymethyl methacryl ate block having a acrylic acid and butyl acrylate gradient (MMA-BA/AA), denoted as P(MMA-BA/AA)-b-P(BA/AA)-b-P(MMA-BA/AA). The ‘b’ represents block and denotes the transition from the midblock composition to the endblocks.

### Example 2

24.239 grams (0.00958 moles) of dialkoxyamine solution from above were mixed with 67.639 grams (0.939 moles) acrylic acid and 383.330 grams (2.99 moles) of butyl acrylate in a suitable container. The mixture was bubbled with nitrogen for 10 minutes to deactivate the inhibitor present in the monomers. Following that treatment, the solution was poured into a 1 L stainless steel polymer reactor, capable of handling >100 psi, with mechanical stirring and sampling valve. Polymerization was carried out at 110-120° C. until 90% conversion (about 4 hours). The resulting first block mixture was diluted with 168 grams of toluene.

A triblock copolymer was prepared by mixing 408 g of the above mixture with 151.227 g (1.51 moles) methyl methacrylate and an additional 47.337 g of toluene. The MMA was polymerized to 80% conversion, resulting in endblocks with 88% PMMA, 10% BA and 1.6% AA.

### Example 3

Preparation of a mixture of an acid functionalized polymethyl methacrylate-polybutyl acrylate gradient block copolymer (as given in example 1) and a random copolymer of acid functionalized methyl methacrylate and butyl acrylate.

The triblock copolymer synthesis detailed in example 1 can be carried out to the point where the 2^{nd} block conversion reaches 85%. Once 85% conversion is reached a suitable peroxide such as Luperox 575, (a t-amyl peroctoate available form Arkema Inc.) can be added to the reaction and the mixture is held at 115° C. for at least 30 minutes or preferably for 6-7 half-lives. The addition of peroxide at the end of a reaction to eliminate residual monomers is commonly referred to as ‘chasing’ as will be evident to those skilled in the art. The resultant mixture will contain both the block copolymer and a random copolymer of acid functionalized methyl methacrylate and butyl acrylate. The block copolymer composition will be P(MMA/AA)-b-P(BA/AA)-b-P(MMA/AA). The ‘b’ represents block and denotes the transition from the midblock composition to the endblocks.

### Example 4

Example 4 is carried out exactly the same as example 1 except during the first block synthesis, no acrylic acid is added. The resulting block copolymer will have a pure butyl acrylate midblock and endblocks containing a methyl methacrylate and acrylic acid copolymer having a butyl acrylate gradient, denoted as P(MMA/AA-BA)-b-PBA-b-P(MMA/AA-BA). The ‘b’ represents block and. denotes the transition from the midblock composition to the endblocks.

### Example 5

Example 5 is carried out exactly the same as example 1 except during the first block synthesis a suitable acrylic comonomer is substituted for acrylic acid. The resulting block copolymer will have a butyl acrylate-co-acrylate midblock and endblocks containing a methyl methacrylate and acrylic acid copolymer having a butyl acrylate gradient, denoted as P(MMA/AA-BA)-b-PBA/coacrylic-b-PMMA/AA-BA). The ‘b’ represents block and denotes the transition from the midblock composition to the endblocks.

### Example 6

Example 6 is carried out exactly the same as example 1 except that after the first block synthesis, the residual monomers are removed via vacuum distillation prior to endblock addition. The resulting block copolymer will have a butyl acrylate-co acrylic acid midblock and endblocks containing methyl methacrylate, denoted as P(MMA)-b-PBA/AA-b-P(MMA). The ‘b’ represents block and denotes the transition from the midblock composition to the endblocks.

### Example 7

Example 7 is carried out exactly the same as example 6 except during the endblock synthesis butyl acrylate is added as a comonomer. The resulting block copolymer will have a butyl acrylate-co-acrylic acid midblock and endblocks containing a methyl methacrylate and butyl acrylate copolymer having a butyl acrylate gradient, denoted as P(MMA/BA)-b-PBA/AA-b-P(MMA/BA). The ‘b’ represents block and denotes the transition from the midblock composition to the endblocks.

While the present invention has been described with respect to particular embodiments thereof, it is apparent that numerous other forms and modifications of this invention will be obvious to those skilled in the art The appended claims and this invention generally should be construed to cover all such obvious forms and modifications which are within the true spirit and scope of the present invention.

What is claimed is:

1. A block copolymer comprising at least two different monomer blocks wherein at least one of said two different monomer blocks comprises a methyacrylate block and at least one of said two different monomer blocks comprises a butylacrylate block, and wherein at least two adjacent monomer block are a gradient copolymer, and wherein at least one of said different monomer blocks contains acid functionality and wherein said block copolymer is formed via nitroxide mediated controlled free radical techniques.

2. The block copolymer of claim 1 wherein said acid functionality is provided by one or more acid monomer units.

3. The block copolymer of claim 2 wherein said one or more acid monomer units is present in said at least one of said different monomer or polymer blocks in an amount of at least 5 mole percent.

4. The block copolymer of claim 2 wherein said one or more acid monomer units is present in said at least one of said different monomer or polymer blocks in an amount of at least 25 mole percent.

5. The block copolymer of claim 2 wherein said one or more acid monomer units is present in said at least one of said different monomer or polymer blocks in an amount of at least 50 mole percent.

6. The block copolymer of claim 1 wherein said nitroxide comprises a sequence of the formula: 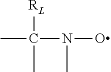
in which the R_{L} radical has a molar mass greater than 15 and wherein R_{L} comprises a phosphoryl group represented by the formula: 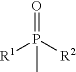
in which R¹ and R², which can be identical or different, is selected from the group consisting of alkyl, cycloalkyl, alkoxy, aryloxy, aryl, aralkyloxy, perfluoroalkyl and aralkyl radicals ,a halogen atom, and at least one aromatic ring.

7. The block copolymer of claim 2 wherein said acid is selected from acrylic acid, methacrylic acid, maleic acid; fumaric acid; crotonic acid; itaconic acid, carboxyethyl acrylate, acrylamido 2-methyl 2 propane sulfonate or styrene sulfonic acid.

8. The block copolymer of claim 2 wherein said acid is formed by hydrolyzing a corresponding anhydride selected from maleic anhydride, fumaric anhydride or itaconic anhydride.

9. The block copolymer of claim 2 wherein said acid is formed by hydrolyzing a corresponding protected ester selected from tertbutyl acrylate or tertbuty methacrylate.

10. The block copolymers of claim 1 synthesized via a bulk, solution, suspension, or emulsion polymerization processes.

11. The block copolymer of claim 1 comprising a triblock copolymer wherein at least 1 block segment contains acid functionality and each 2 adjacent segments are gradient copolymers.

12. The block copolymer of claim 1 comprising a triblock copolymer wherein at least 2 block-segments contains acid functionality and each 2 adjacent segments are gradient copolymers.

13. The block copolymer of claim 1 wherein said acid functionality has been partially or completely neutralized.

14. A block copolymer of claim 1 comprising a triblock of polymethylmethacrylate-b-polybutylacrylate-b-polymethylmethacrylate wherein at least one block includes acid functionality and at least two adjacent blocks comprise a gradient structure.

15. A block copolymer of claim 1 comprising a triblock copolymer of polymethylmethacylate-b-polybutylacrylate-b-polymethylmethacrylate wherein at least one block includes acid functionality and each two adjacent blocks comprise a gradient structure.

16. A block copolymer of claim 1 comprising a triblock copolymer of polymethylmethacylate-b-polybutylacrylate-b-polymethylmethacrylate wherein at least two blocks include acid functionality and at least two adjacent blocks comprise a gradient structure.
